(19) United States
(12) Patent Application Publication
(10) Pub. No.: US 2024/0104889 A1
(43) Pub. Date: Mar. 28, 2024

(54) On Head Detection based on Simulated Proximity Sensor using IR Cameras

(71) Applicant: Apple Inc., Cupertino, CA (US)

(72) Inventors: Alper Yildirim, San Francisco, CA (US); Chia-Yin Tsai, Sunnyvale, CA (US); Hao Qin, Saratoga, CA (US); Hua Gao, San Jose, CA (US); Tom Sengelaub, Oakland, CA (US); Martin Subert, Sestajovice (CZ); Petr Bour, Ricany (CZ)

(21) Appl. No.: 18/469,670

(22) Filed: Sep. 19, 2023

Related U.S. Application Data
(60) Provisional application No. 63/376,881, filed on Sep. 23, 2022.

(51) Int. Cl. G06V 10/60; G06V 10/25; G06V 10/74; G06V 10/75

(52) U.S. Cl. CPC G06V 10/60; G06V 10/25; G06V 10/758; G06V 10/761; G06V 2201/07

(57) ABSTRACT

A system for detecting a proximate object includes one or more cameras and one or more illuminators. The proximate object is detected by obtaining image data captured by the one or more cameras, where the image data is captured when at least one of the one or more illuminators are illuminated, determining brightness statistics from the image data, and determining whether the brightness statistics satisfies a predetermined threshold. The proximate object is determined to be detected in accordance with a determination that the brightness statistics satisfies the predetermined threshold.

### FIELD OF THE INVENTION

This disclosure relates generally to image processing. More particularly, but not by way of limitation, this disclosure relates to techniques and systems for monitoring a physical environment using infrared (IR) cameras to detect proximate objects.

### BACKGROUND

In modern times, electronic devices can allow a user to interact with the user's environment in new ways. As an example, in augmented reality or mixed reality environments, a user can interact with the environment by viewing a representation of the environment that has both physical and virtual objects. Devices that provide such extended reality capabilities are often equipped with cameras and other sensors which allow the device to provide such a representation to the user. However, these devices often lack a proximity detector. What is needed is a technique to detect proximity without the use of a proximity sensor.

### BRIEF DESCRIPTION OF THE DRAWINGS

FIG. 1 shows an example diagram of an electronic device modifying an operation in response to detection of a user proximate to the device, according to one or more embodiments.

FIG. 2 shows a flowchart of a technique for determining whether a proximate object is detected, according to one or more embodiments.

FIG. 3 shows, in flowchart form, an example process for performing image data analysis to determine brightness statistics, in accordance with one or more embodiments.

FIG. 4 shows example brightness statistics for a head mounted device (HMD), in accordance with one or more embodiments.

FIG. 5 depicts a flowchart of a technique for using brightness statistics to detect proximate objects, in accordance with one or more embodiments.

FIG. 6 depicts a flowchart of a technique for a temporal detection of proximate objects, in accordance with one or more embodiments.

FIG. 7 shows, in block diagram form, an example device diagram, according to one or more embodiments.

FIG. 8 shows, in block diagram form, a mobile device in accordance with one or more embodiments.

### DETAILED DESCRIPTION

In general, embodiments described herein are directed to a technique for adjusting an operation of a device in response to a detect proximate object. In some embodiments, brightness statistics of image data captured by an infrared (IR) camera may be analyzed to determine whether a proximate threshold is satisfied and, thus, a proximate object is detected.

In some embodiments, techniques include obtaining image data captured by one or more cameras. The cameras may be IR cameras, or other cameras capturing image data from which brightness may be analyzed. The image data may be captured in a single frame, or a series of frames such as a video sequence. The brightness from the images may be analyzed to determine brightness statistics. Brightness statistics may indicate, for example, a peak brightness, an average brightness, and the like. In some embodiments, the amount of an image as a particular brightness may be determined. That is, a brightness for each pixel may be determined and compared to determine the amount of an image within a particular brightness range. In some embodiments, a determination that a predetermined amount of the image data is within a brightness range, then a determination may be made that a proximate object is detected. If the overall brightness for the image data is determined to be within a predetermined range, then a resulting action may be taken by the device. For example, in some embodiments, when a proximate object is detected by the device, then one or more systems of the device may be powered on, such as a display or other systems. This may be preferable, for example, where the system is a wearable device, and the detection of a proximate object indicates that a user is wearing the wearable device.

In turn, the operations of the system may be suppressed, or powered down, in response to a determination that a proximate object is no longer detected. For example, a determination may be made, based on the brightness statistics for additional frames, that a proximate object is no longer. Accordingly, one or more systems may be powered down, such as a display of the device or the like. Returning to the example of the wearable device, this may be preferable such that when a proximate object is no longer detected, it may be inferred that a user is no longer wearing the device, and, thus, certain systems of the device, such as the display, can be powered down.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed concepts. In the interest of clarity, not all features of an actual implementation may be described. Further, as part of this description, some of this disclosure's drawings may be provided in the form of flowcharts. The boxes in any particular flowchart may be presented in a particular order. It should be understood, however, that the particular sequence of any given flowchart is used only to exemplify one embodiment. In other embodiments, any of the various elements depicted in the flowchart may be deleted, or the illustrated sequence of operations may be performed in a different order, or even concurrently. In addition, other embodiments may include additional steps not depicted as part of the flowchart. Moreover, the language used in this disclosure has been principally selected for readability and instructional purposes and may not have been selected to delineate or circumscribe the inventive subject matter, it being necessary to resort to the claims in order to determine such inventive subject matter. Reference in this disclosure to “one embodiment” or to “an embodiment” means that a particular feature, structure, or characteristic described in connection with the embodiment is included in at least one embodiment of the disclosed subject matter, and multiple references to “one embodiment” or “an embodiment” should not necessarily be understood as all referring to the same embodiment.

It will be appreciated that, in the development of any actual implementation (as in any software and/or hardware development project), numerous decisions must be made to achieve a developer's specific goals (e.g., compliance with system- and business-related constraints) and that these goals may vary from one implementation to another. It will also be appreciated that such development efforts might be complex and time-consuming but would nevertheless be a routine undertaking for those of ordinary skill in the design and implementation of multi-modal processing systems having the benefit of this disclosure.

Various examples of electronic systems and techniques for using such systems in relation to various technologies are described.

A physical environment, as used herein, refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust the characteristic(s) of graphical content in the XR environment in response to representations of physical motions (e.g., vocal commands).

There are many different types of electronic systems that enable a person to sense and/or interact with various XR environments. Examples include: head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

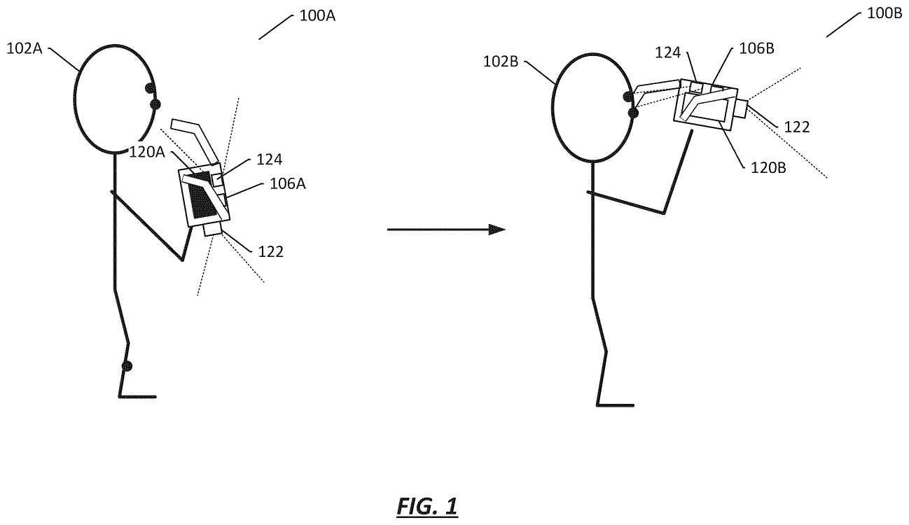

Turning to FIG. 1, an example environment diagram is presented, in accordance with one or more embodiments. It should be understood that the various components and description are provided for example purposes, and are not necessarily intended to limit the disclosure.

As shown in diagram 100A, a user 102A is handling an electronic device 106A. In particular, electronic device 106 is depicted as a head mounted device. However, any kind of mobile electronic device may be used. The electronic device may include, for example, a display 120A, which as presented is powered down. Thus, the display 120A is depicted as black. The electronic device 106A may additionally include one or more sensors which may capture image data and other sensor data related to the environment surrounding the electronic device 106. For example, the device 106 may include back facing sensors 122, which capture data of environment facing away from the user. This may include, for example, one or more cameras were camera systems which capture image data of the environment, depth sensors, ambient light sensor use, and the like.

The electronic device may include one or more front facing sensors 124. This may include, for example, user facing cameras, depth sensors, and the light sensor is, and the like. Accordingly, the user facing sensors 124 can capture image data of the user when the user is utilizing the electronic device 106. Further, the user facing sensors 124 may include additional data to facilitate the user interacting with an environment via the electronic device 106. For example, the user facing sensors may include gaze tracking sensors and the like. The sensors may be used in association with other components to capture data related to a user's by or eyes, from which gaze information may be determined, such as a gaze vector. The gaze tracking sensors may additionally capture information regarding the users by or eyes such as people location, distance of the eye from the device, relative pose to the device, and the like.

In some embodiments the user facing cameras may include, for example, one or more RGB cameras, depth cameras, IR cameras, and the like. In some embodiments, the IR cameras may be used in conjunction with other components of the electronic device 106 to obtain useful sensor data related to the user 102A. For example, the electronic device 106 may be equipped with one or more light emitting diodes (LEDs) or other lighting components facing the user which, when illuminated, allow user facing cameras to capture better lit images of the user or other objects proximate to the device.

Turning to diagram 100B, the user 102B may begin interacting with the electronic device 106 by lifting the electronic device 106 the to the user face. As another example, the electronic device 106 may be a wearable device, and the user 102B may mount the device 106B onto the user. For purposes of the example in diagram 100B, the user 102B has lifted the device 106B such that the device is proximate to the user. In some embodiments, the device may perform analysis of image data capture by the front facing sensors 124 to confirm or determine such proximity. In some embodiments, the image data and analyze may be captured by a camera, such as an IR camera, while one of the lighting components are activated. For example, in one embodiment, a front facing IR camera may capture data while user facing LEDs are illuminated. The image data analyzed for brightness statistics may be collected from such illuminated image data. In response to detecting a proximity, the electronic device 106B can power up one or more device systems, such as display 120B. As such, as depicted in diagram 100B, the display 120B is depicted as turned on, with content being presented to the user.

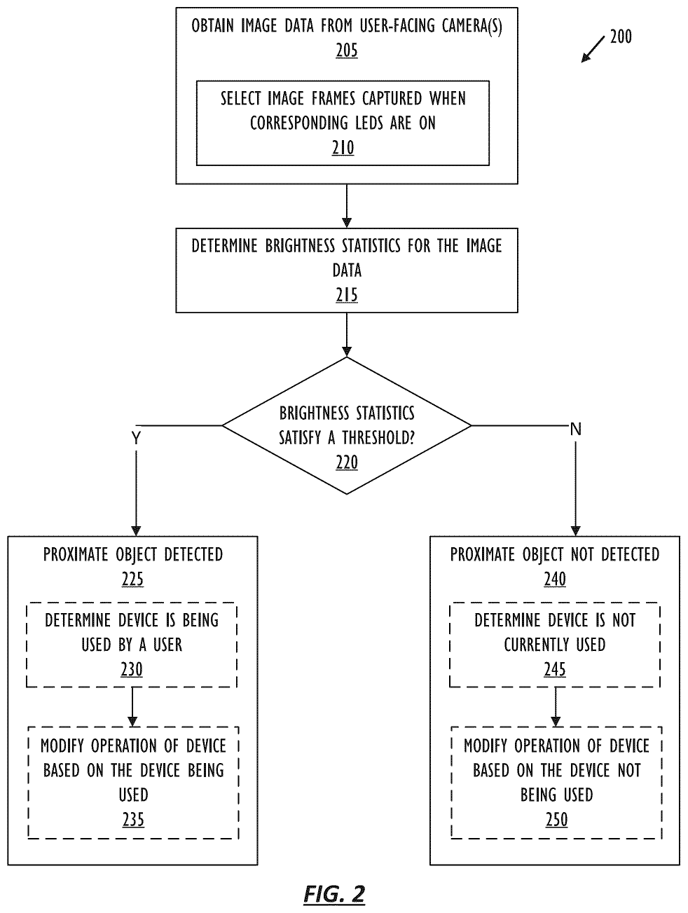

Turning now to FIG. 2, flowchart of a technique for determining whether a proximate object is detected, according to one or more embodiments. For purposes of explanation, the following steps will be described in the context of FIG. 1. However, it should be understood that the various actions may be taken by alternate components. In addition, the various actions may be performed in a different order. Further, some actions may be performed simultaneously, and some may not be required, or others may be added, according to various embodiments.

The flowchart 200 begins at block 205, where image data is obtained from user facing cameras. In some embodiments, the device may simulate proximity sensors in a variety of contexts, and thus the cameras need not be user facing. For example, techniques described herein can be used to simulate proximity sensors based on image data captured from alternative cameras on the device. Optionally, as shown at block 210, the image frames captured by the cameras may be selected for analysis because the frames are lit by lighting components on the device. For example, LEDs may be affixed on the device in the same direction as the cameras capture the image data. In some embodiments, the frames captured by the cameras may be selected upon a determination that the frames were captured while the LEDs or other lighting components are lit. As such, the images used for analysis may be selected from among lit images.

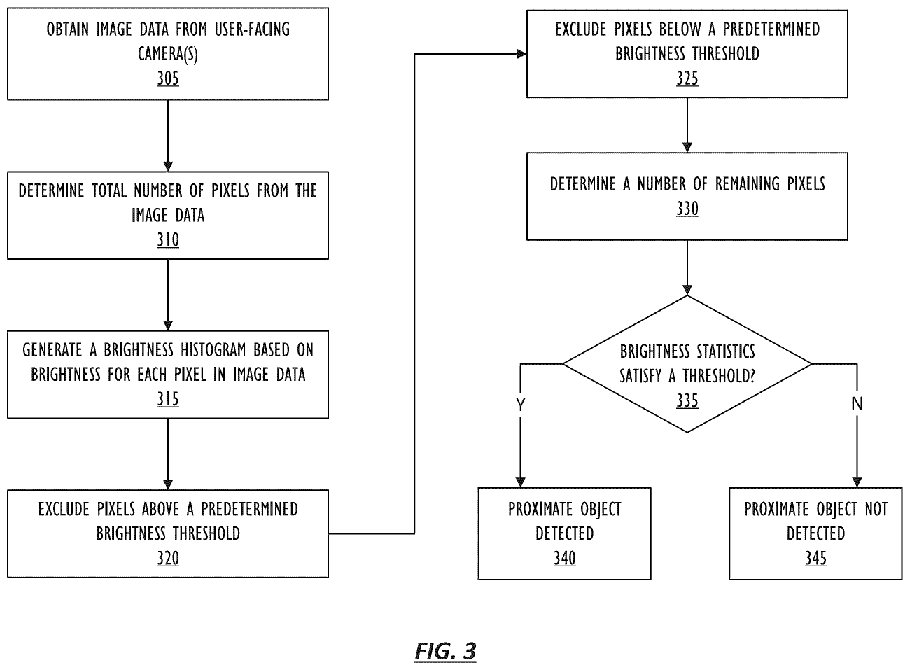

The flowchart 200 continues at block 215, where brightness statistics for the image data are determined. These brightness statistics will be described in greater detail below with respect to FIG. 3. However, in general, the brightness statistics include a distribution brightness or intensity values for the image. In some embodiments, the brightness or intensity value may be determined for the pixels in the image frame, or a sample set of pixels in the image data. In accordance with some embodiments, where no proximate object is present, the pixels will be associated with a low intensity value. However, because lighting components may be lit when the images captured, the image may include pixels of saturated intensity, which may be caused by the cameras capturing the lit lighting components in the image. Accordingly, determining brightness statistics may additionally include detecting pixels with a saturated intensity, which should be excluded when determining whether a proximate object is present.

The flowchart continues to block 220, where a determination is made as to whether the brightness statistics satisfy a threshold. According to some embodiments, the threshold may be defined based on a portion of the image at which pixels are associated with a predefined range of brightness values. Said another way, as described above, pixels of saturated intensity should be suppressed to exclude image noise. Further, low brightness pixels may occur when the light is not reflecting on anything near the cameras, and thus the pixels may be associated with a very low brightness for intensity value. Accordingly, a sufficient portion of the pixels of the frame having brightness or intensity values in the middle range may indicate that a proximate object is detected.

If at block 220, a determination is made that the brightness statistics satisfy a threshold, then the flowchart proceeds to block 225. At block 225, it is determined that a proximate object is detected. Optionally, as shown at block 230, the fact that the proximate object is detected may cause the device to determine that the device is being used. Certain embodiments described herein may be utilized particularly for wearable devices. As such, the determination may indicate that a wearable device currently being worn based on the detection of the proximate object. In turn, at block 235, operation of the device may be modified based on the determination of the device is being used. In some embodiments, detection of the proximate object may cause a change in operation of the device. For example, systems of the electronic device may be powered on, such as a display device or other systems of the device.

If at block 220, a determination is made that the brightness statistics fail to satisfy a threshold, then the flowchart proceeds to block 240. At block 240, it is determined that a proximate object is not detected. Optionally, as shown at block 240, the fact that the proximate object is not detected may cause the device to determine that the device is not being used. Because certain embodiments described herein may be utilized particularly for wearable devices, the determination may indicate that a wearable device is not currently being worn based on the lack of detection of the proximate object. In turn, at block 250, operation of the device may be modified based on the determination of the device is being used. In some embodiments, detection of the proximate object may cause a change in operation of the device. For example, systems of the electronic device may be powered down, such as a display device or other systems of the device.

FIG. 3 shows, in flowchart form, an example process for performing image data analysis to determine brightness statistics, in accordance with one or more embodiments. For purposes of explanation, the following steps will be described in the context of FIG. 1. However, it should be understood that the various actions may be taken by alternate components. In addition, the various actions may be performed in a different order. Further, some actions may be performed simultaneously, and some may not be required, or others may be added, according to various embodiments.

The flowchart 300 begins at block 305, where image data is obtained from user-facing cameras. In some embodiments, the device may simulate proximity sensors in a variety of contexts, and thus the cameras need not be user facing. For example, techniques described herein can be used to simulate proximity sensors based on image data captured from alternative cameras on the device. The cameras may include, for example, RGB cameras, depth cameras, IR cameras, and the like.

At block 310, a total number of pixels is determined from the image data. The pixels may include all pixels in a particular frame or set of frames, or may include a sampling of pixels for one or more frames. In some embodiments, the one or more frames considered for determining brightness statistics may be selected from among image frames captured by the cameras and limited to image frames captured when a lighting component is actively lighting the environment captured by the cameras. For example, image frames may be selected from a series of frames captured by IR cameras as it is captured during the limitation of one or more LEDs on the device facing for the environment captured by the cameras.

The flowchart 300 continues at block 315, where the brightness histogram is generated based on a brightness for each pixel of the total pixels determined at block 310. The brightness histogram may indicate a count of pixels identified at each brightness value. As such, for a given frame or set of frames, the histogram may indicate how many pixels are associated with a particular brightness or intensity value. In some embodiments, a determination is made as to pixels within a predetermined range of brightness or intensity. As such, the histogram may be clipped between two brightness values. At block 320, pixels are excluded which are above a predetermined brightness threshold. Pixels which are associated with a brightness value above a threshold may indicate that the pixels are associated with stray light from the illuminating devices, for example. As such, discounting the pixel associated with a very high brightness value reduces image noise. Further, as shown at block 325, pixels below a predetermined brightness threshold are also excluded when clipping the histogram. According to some embodiments, pixels below a predetermined brightness threshold may indicate that the light did not reach any proximate object from which to provide a sufficient intensity value.

The flowchart 300 continues at block 330, where a number of remaining pixels are determined. For example, the number of remaining pixels may be determined be determined based on the clipped histogram, by determining how many pixels are considered within the predefined range (that is, pixels which were not excluded at block 320 or block 325). According to some embodiments, the threshold may be based on a minimum percentage of the pixels for which a little brightness value is detected. As such, in some embodiments, the minimum percentage of pixels for which the brightness value is associated with a middle brightness or intensity indicates a portion of the image or images associated with the middle brightness or intensity values. At block 335, a determination is made as to whether a sufficient number of the remaining pixels satisfy the threshold. If a determination is made that a sufficient number of remaining pixels satisfy the threshold, then the flowchart concludes at block 340, and the system determines a proximate object is detected. By contrast, returning to block 335, if a determination is made that the brightness statistics do not satisfy the threshold, then the flowchart concludes at block 345, and the system determines that a proximate object is not detected.

In some embodiments, additional considerations may be made to resolve unique lighting situations which may cause additional noise in the data. For example, in the case of a presence of an external strong stray light, frames may be captured in an interleaved fashion where the lighting component, such as the LED, is lit from one image, and not let in the next image. The unlit image may be subtracted from the lit image prior to determining the number of pixels at block 310. As such, the technique described in FIG. 3 may be applied to the difference image.

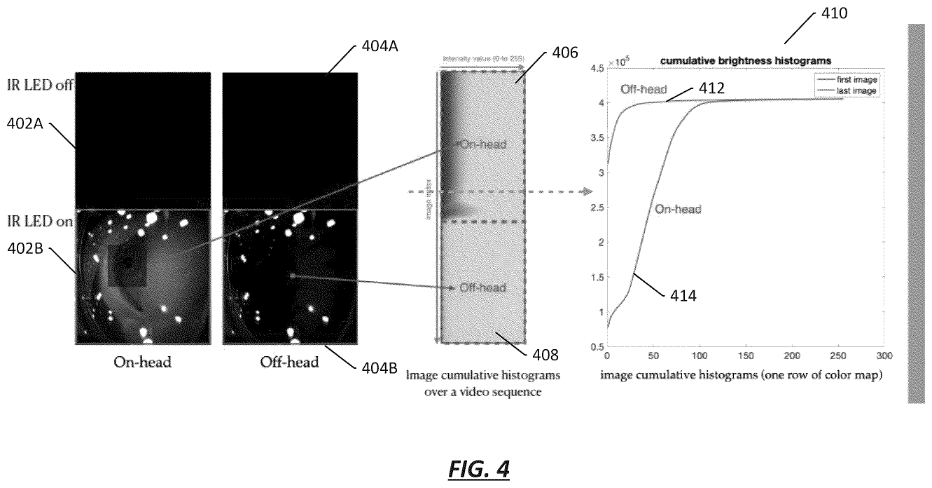

FIG. 4 shows example brightness statistics for a head mounted device (HMD), in accordance with one or more embodiments. As such, FIG. 4 depicts an example data set for the technique described above with respect to FIG. 3.

FIG. 4 depicts four image frames captured by cameras on the device. Image frame 402A depicts an example image frames captured by a head mounted device, wherein the device is being worn by the user, and one or more associated LEDs are off and, thus, not lighting the environment. By contrast, the image frame 402B depicts a frame where the device is being worn by the user, and one or more associated LEDs are on, and thus lighting the environment captured in the frame. As such, image frame 402A depicts a uniformly dark frame, whereas Image frame 402B depicts a frame with middle brightness values visible in the frame.

Similarly, differences in the view of frames are also apparent when a device is not being worn by a user. As such, image frame 404A depicts of an image frame captured by a camera when the wearable device is not being worn, and the LEDs are off and, thus, not lighting the environment. By contrast, frame 404B depicts an image frame captured when the device is not being worn by the user, but the LEDs are illuminated related as such, stray lighting can be depicted in the form of rights pixels in the frame, however the remainder of the frame remains substantially dark.

As described above, when selected frames for analysis, the frames considered may be limited to those for which the lighting components are illuminating the environment. As such, histograms 406 and 408 are provided for frames 402B and 404B, within which the scene is illuminated by the LEDs. In particular, histogram 406 relates to a cumulative histogram over video sequence of image frames, such as frame 402B, where the proximate object is detected. By contrast, histogram 408 depicts a cumulative histogram over video sequence when the head is removed. Further, the image frames 402A and 404A are not considered. Histogram 406 corresponds to the image frame 402B. In particular, histogram 406 depicts a histogram of pixels based on brightness urgency values for each of the pixels (or sampled pixels from the frame). As made clear that histogram, the image frame for to be includes a substantial number of pixels having a middle brightness value. This is clear when comparing histogram 406 to histogram 408, which is associated with cumulative frames over video sequence for which a proximate object is not detected, such as image frame 404B. As shown in histogram 408, the vast majority of the pixels are depicted with a very low brightness value. The exception is the very bright pixels, which are associated with the strata lighting from the LEDs.

This distinction is further made clear when considering the chart at 410. This chart shows a first set of charted cumulative brightness in each of the frames. Line 412 shows that the cumulative histogram for frames for which no proximate object is detected, very little range of brightness or intensity is provided. By contrast, line 414 shows that the cumulative histogram for frames for which a proximate object is detected, and there is a greater range of brightness among the pixels.

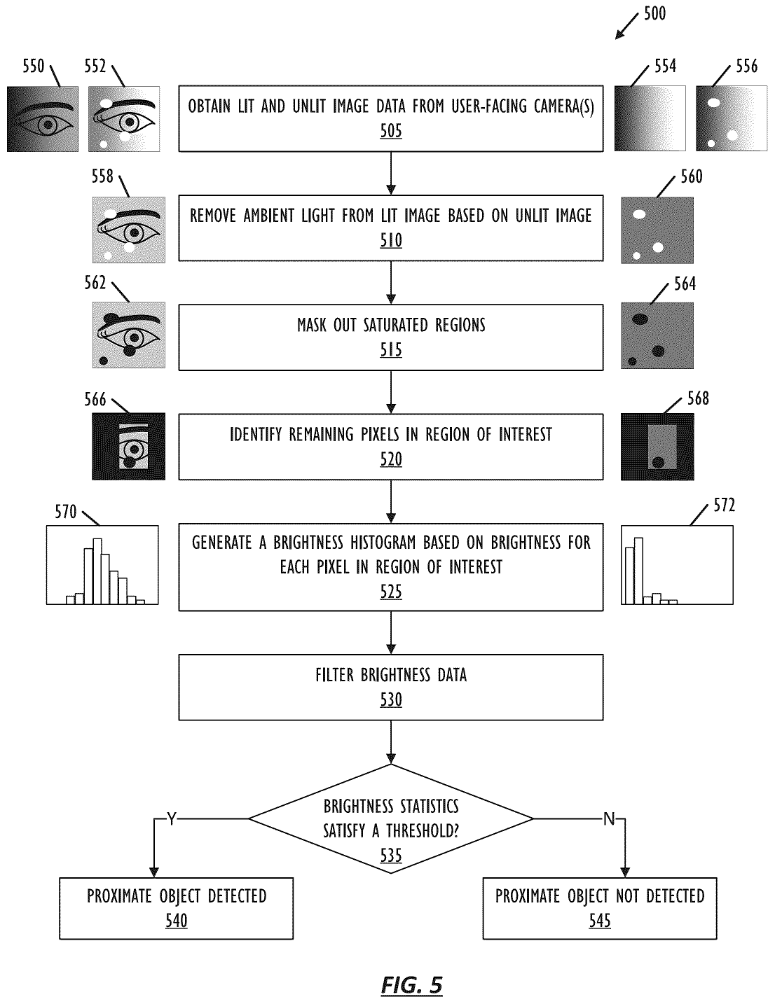

According to one or more embodiments, additional processing may be performed on the image data in order to detect proximate objects using brightness. FIG. 5 depicts a flowchart of a technique for using brightness statistics to detect proximate objects, in accordance with one or more embodiments. For purposes of explanation, the following steps will be described in the context of FIG. 1. However, it should be understood that the various actions may be taken by alternate components. In addition, the various actions may be performed in a different order. Further, some actions may be performed simultaneously, and some may not be required, or others may be added, according to various embodiments.

The flowchart 500 begins at block 505, where a lit and unlit image are obtained from one or more user-facing cameras. In some embodiments, a lit image and unlit image are captured from a camera situated in front of each eye. The lit images may be captured concurrently, and the unlit images may be captured concurrently. In some embodiments, a head mounted device may include illuminators, such as LEDs or the like facing toward one or both of the eyes. The head mounted device may additionally have one or more cameras facing toward the eyes. In some embodiments, the cameras capture one or more lit images when the illuminators are active, and one or more unlit images when the illuminators are inactive. To determine whether a proximate object is detected, a first frame pair is captured including a frame capturing each eye while the illuminators are active. A second frame pair is also captured including a frame capturing each eye while the illuminators are not active. Thus, in some embodiments, the lit and unlit image data may include a lit frame for each eye and an unlit frame for each eye.

For purposes of the example depicted in FIG. 5, a first example of frame pair is depicted including unlit frame 550 and lit frame 552. These are examples of two frames captured while an HMD is donned by a user. Unlit frame 550 shows a frame captured without illuminators on the HMD being activated, while lit frame 552 shows a frame captured while illuminators are active. These two frames may be captured concurrently, for example, within a predetermined time period. Separately, a second example frame pair is shown including unlit frame 554, and lit frame 556, which are captured while the HMD is not donned by a user. Unlit frame 554 is captured while illuminators are not activated, while lit frame 556 is captured while the illuminators are activated. These two frames may be captured concurrently, for example, within a predetermined time period.

The flowchart 500 continues to block 510, where ambient light is removed from the lit image based on the unlit image. As described above, a lit and unlit image may be obtained for each eye. As such, in some embodiments, the ambient light is removed from the lit image of each eye. The unlit image may capture lighting in the environment which is not caused by the illuminators, thereby providing ambient light. The ambient light may be present, for example, based on windows in the environment, lamps, overhead lights, and the like. In the first example shown, frame 558 depicts a modified lit image 558 in which ambient light is removed. That is, the light that appears in unlit image 550 is subtracted from the lit frame 552. Similarly, in the second example, the ambient light present in frame 554 is subtracted from lit image 556 to obtain modified lit image 560.

At block 515, saturated regions are masked out from the modified lit image. The saturated regions occur, for example, as a reflection of the light emitted from the illuminators on the device. In some embodiments, by masking out the saturated regions, the reflection from the illuminators may be less likely to affect the overall brightness statistics for the frame. In some embodiments, the masked region may include detected portions of the image data having a brightness above a predetermined threshold. The mask may be applied to the portion or portions of the region satisfying the predetermined threshold. Thus, in the first example, 562 presents a masked image in which the saturated regions of the modified lit image 558 are masked out. Similarly, in the second example, 564 presents a masked image in which the saturated regions of the modified lit image 560 are masked out. In some embodiments, a margin may be applied such that the masked region includes the saturated portions as well as a predefined amount of additional image data surrounding the saturated portions.

The flowchart proceeds to block 520, where pixels within a region of interest are identified. The region of interest may include a predefined portion of the frame. In some embodiments, the region of interest may differ between a left eye image and a right eye image. The region of interest may be any shape, such as an elliptical shape, rectangular shape, or the like. In some embodiments, the region of interest may include a predefined portion of the frame without regard for the content presented in the frame. In the first example, the region of interest of the masked image 562 is identified at 566. Similarly, in the second example, the region of interest of the masked image 564 is identified at 568.

At block 525, a brightness histogram is generated based on brightness for each pixel in the region of interest. The brightness histogram may indicate a count of pixels identified at each brightness value or set of brightness values within the region of interest. As such, for a given frame or set of frames, the histogram may indicate how many pixels are associated with a particular brightness or intensity value. Thus, in the first example, the histogram 570 presents a histogram indicative of the mid-range brightness values in the region of interest 566. By contrast, in the second example, the histogram 572 presents a histogram indicative of lower brightness values in line with the darker region of interest 568.

The flowchart proceeds to block 530, where the brightness data is filtered. In some embodiments, a determination is made as to pixels within a predetermined range of brightness or intensity. As such, the histogram may be clipped between two brightness values. At block 320, pixels are excluded which are above a predetermined brightness threshold. In doing so, noise in the brightness data may be reduced.

At block 535, a determination is made as to whether the brightness statistics satisfy a predetermined threshold. In some embodiments, multiple threshold values may be used and the particular threshold value used may be based on a current status of the device. For example, if a proximate object is detected such that the device is considered to be on a user's head, then a higher brightness value may be used than if the device is currently determined to not be on a user's head. The brightness statistics may include determining whether a particular brightness, such as a mean brightness or median brightness, satisfies one or more predefined threshold values.

If a determination is made that the brightness statistics satisfy a threshold, then the flowchart conclude at block 540, and a proximate object is determined to be detected. By contrast, if at block 535, a determination is made that the brightness statistics do not satisfy the threshold, then the flowchart conclude at block 545 and it is determined that a proximate object is not detected. As described above, in some embodiments, the brightness statistics not satisfying a threshold may be a lower threshold value than the determination that the brightness statistics satisfy a threshold. As such, the determination may be made based on whether the brightness statistics exceed or fall below a predefined range.

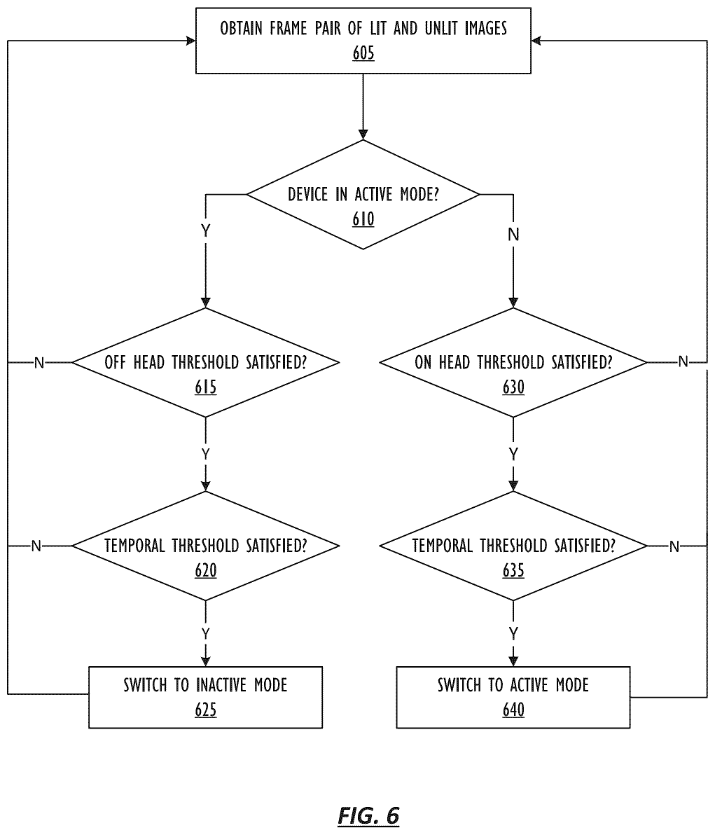

In some embodiments, a determination of whether a proximate object is detected may be part of a temporal determination as to whether a device is on head or off head. For example, in order to determine that a device is on head or off head may be based on a series of detections of proximate objects. Moreover, some embodiments include consideration of one or both eyes in detecting proximate objects and/or determining whether a device is on head. FIG. 6 depicts a flowchart of a technique for a temporal detection of proximate objects, in accordance with one or more embodiments. In particular, FIG. 6 depicts an example flow for determining whether a device is in an active or inactive mode, and can occur in conjunction with the detection of proximate objects as described above with respect to FIG. 5. For purposes of explanation, the following steps will be described in the context of FIG. 5. However, it should be understood that the various actions may be taken by alternate components. In addition, the various actions may be performed in a different order. Further, some actions may be performed simultaneously, and some may not be required, or others may be added, according to various embodiments.

The flowchart begins at block 605, where a pair of lit and unlit images are obtained from user-facing cameras. For example, illuminators may be active while a first set of images are captured by the user-facing cameras. Then, another set of images are captured while illuminators are inactive. These cameras may be situated, for example, in front of a user's eyes. In some embodiments, a single camera may be used and may or may not align with a user's eye. Additionally, or alternatively, cameras may be situated in a head mounted device to face each user's eye or eye region.

At block 610, a determination is made as to whether the device is in an active mode. According to one or more embodiments, the device may be considered in an active mode if the device is being worn by a user. The device may be considered to be worn by a user, for example, if a proximate object is detected based on the image data captured by the user-facing cameras, as will be described below.

If a determination is made that the device is currently in an active mode, then the flowchart proceeds to block 615, where a determination is made as to whether an off head threshold is satisfied. That is, the brightness statistics for the pixels in the images are used to determine whether the threshold value is satisfied, for example as described above with respect to FIG. 5. As described above, in some embodiments, the threshold may be associated with a brightness threshold value under which a proximate object is determined to not be detected. As such, the threshold value for determining that the device is no longer on head may be lower than a brightness value used to determine whether the device is on head. If the off head threshold value is not satisfied, then the flowchart returns to block 605, and the device continues to capture lit and unlit images.

Returning to block 615, if a determination is made that the off head threshold is satisfied, then the flowchart proceeds to block 620, where a determination is made as to whether a temporal threshold is satisfied. For example, in order to switch from an active mode to an inactive mode, a determination may be made that the off head threshold is satisfied for a predefined number of frames, or for a predefined time period. That is, if a single frame indicates that the off head threshold is satisfied, the result is disregarded as an anomaly if it is among a set of temporally captured frames which otherwise do not satisfy the off head threshold. Further, in some embodiments, the temporal threshold may require the consideration of image data captured from one or more cameras. As an example, in some embodiments, in order to switch from an active mode to an inactive mode, image data from multiple cameras on the device (such as cameras configured to be directed at each eye) may indicate that the off head threshold is satisfied. That is, a separate determination may be made for image data captured from each of one or more cameras on the head mounted device. Thus, if the temporal threshold is satisfied, then the flowchart proceeds to block 625, and the device is switched to an inactive mode, and the flowchart proceeds to block 605, where the device continues to capture frame pairs of lit and unlit images.

Returning to block 610, if a determination is made that the device is not in an active mode (i.e., the device is considered to be in an inactive mode), then the flowchart proceeds to block 630. At block 630, a determination is made as to whether an on head threshold is satisfied. That is, the brightness statistics for the pixels in the images are used to determine whether the threshold value is satisfied, for example as described above with respect to FIG. 5. As described above, in some embodiments, the threshold may be associated with a brightness threshold value under which a proximate object is determined to be detected. As such, the threshold value for determining that the device is on head may be higher than a brightness value used to determine whether the device is off head. If the on head threshold value is not satisfied, then the flowchart returns to block 605, and the device continues to capture lit and unlit images.

Returning to block 630, if a determination is made that the on head threshold is satisfied, then the flowchart proceeds to block 635, where a determination is made as to whether a temporal threshold is satisfied. For example, in order to switch from an active mode to an inactive mode, a determination may be made that the on head threshold is satisfied for a predefined number of frames, or for a predefined time period. That is, if a single frame indicates that the on head threshold is satisfied, the result is disregarded as an anomaly if it is among a set of temporally captured frames which otherwise do not satisfy the on head threshold. Further, in some embodiments, the temporal threshold may require the consideration of image data captured from one or more cameras. As an example, in some embodiments, in order to switch from an active mode to an inactive mode, image data from multiple cameras on the device (such as cameras configured to be directed at each eye) may indicate that the on head threshold is satisfied. That is, a separate determination may be made for image data captured from each of one or more cameras on the head mounted device. Thus, if the temporal threshold is satisfied, then the flowchart proceeds to block 640, and the device is switched to an active mode, and the flowchart proceeds to block 605, where the device continues to capture frame pairs of lit and unlit images.

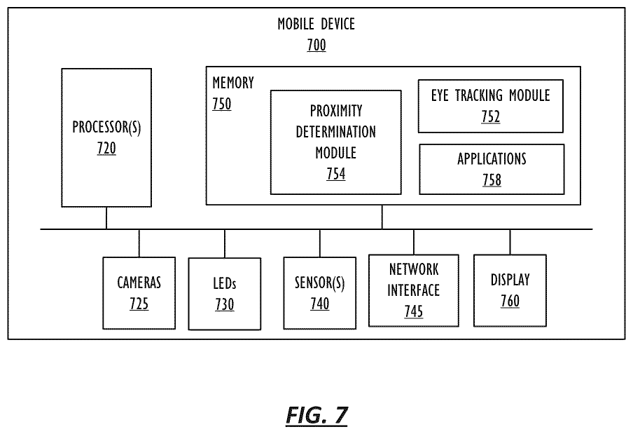

FIG. 7 depicts a system diagram for a system by which various embodiments of the disclosure may be practiced. Specifically, FIG. 7 depicts an electronic device 700 that is a computer system. Electronic device 700 may be part of a multifunctional device, such as a mobile phone, tablet computer, personal digital assistant, portable music/video player, wearable device, head-mounted systems, projection-based systems, base station, laptop computer, desktop computer, network device, or any other electronic system such as those described herein. Electronic device 700 may be connected to other devices across a network using network interface 745. Electronic device 700, may additionally or alternatively communicably connect to one or more additional devices within which the various functionality may be contained or across which the various functionality may be distributed, such as server devices, base stations, accessory devices, and the like. It should be understood that the various components and functionality within electronic device 700 may be differently distributed across the devices or may be distributed across additional devices.

Electronic device 700 includes include a processor 720. Processor 720 may be a system-on-chip, such as those found in mobile devices, and include one or more central processing units (CPUs), dedicated graphics processing units (GPUs), or both. Further, processor 720 may include multiple processors of the same or different type. Electronic device 700 may also include a memory 750. Memory 750 may include one or more different types of memory which may be used for performing device functions in conjunction with processor 720. For example, memory 750 may include cache, ROM, RAM, or any kind of transitory or non-transitory computer readable storage medium capable of storing computer readable code. Memory 750 may store various programming modules during execution, such as a proximity detection module 752 which is configured to determine, based on image data captured by cameras 725, whether a proximate object is detected. In some embodiments, the proximity detection module may use data from eye tracking module 752. Eye tracking module 752 may use user-facing sensors such as one or more cameras 725 or other sensors 740 to determine data regarding a user's eye. For example, the eye tracking module may determine data regarding the state of an eye based on image data captured from a camera 725, such as an IR camera configured to face the eye of a user when the device is worn. In addition, the image data may be captured while one or more lighting components are illuminated, such as LEDs 730. In some embodiments, the cameras and other components used for eye tracking can be used for proximity detection. Further, memory 750 may include one or more additional applications 758.

Electronic device 700 may include a set of sensors 740. In this example, the set of sensors 740 may include one or more image capture sensors, an ambient light sensor, a motion sensor, an eye tracking sensor, and the like. In other implementations, the set of sensors 740 further includes an accelerometer, a global positioning system (GPS), a pressure sensor, and the inertial measurement unit (IMU), and the like.

Electronic device 700 may allow a user to interact with XR environments. Many electronic systems enable an individual to interact with and/or sense various XR settings. One example includes head mounted systems. A head mounted system may have an opaque display and speaker(s). Alternatively, a head mounted system may be designed to receive an external display (e.g., a smartphone). The head mounted system may have imaging sensor(s) and/or microphones for taking images/video and/or capturing audio of the physical setting, respectively. A head mounted system also may have a transparent or semi-transparent see-through display 760. The transparent or semi-transparent display may incorporate a substrate through which light representative of images is directed to an individual's eyes. The display may incorporate LEDs, OLEDs, a digital light projector, a laser scanning light source, liquid crystal on silicon, or any combination of these technologies. The substrate through which the light is transmitted may be a light waveguide, optical combiner, optical reflector, holographic substrate, or any combination of these substrates. In one embodiment, the transparent or semi-transparent display may transition selectively between an opaque state and a transparent or semi-transparent state. In another example, the electronic system may be a projection-based system. A projection-based system may use retinal projection to project images onto an individual's retina. Alternatively, a projection system also may project virtual objects into a physical setting (e.g., onto a physical surface or as a holograph). Other examples of XR systems include heads up displays, automotive windshields with the ability to display graphics, windows with the ability to display graphics, lenses with the ability to display graphics, headphones or earphones, speaker arrangements, input mechanisms (e.g., controllers having or not having haptic feedback), tablets, smartphones, and desktop or laptop computers.

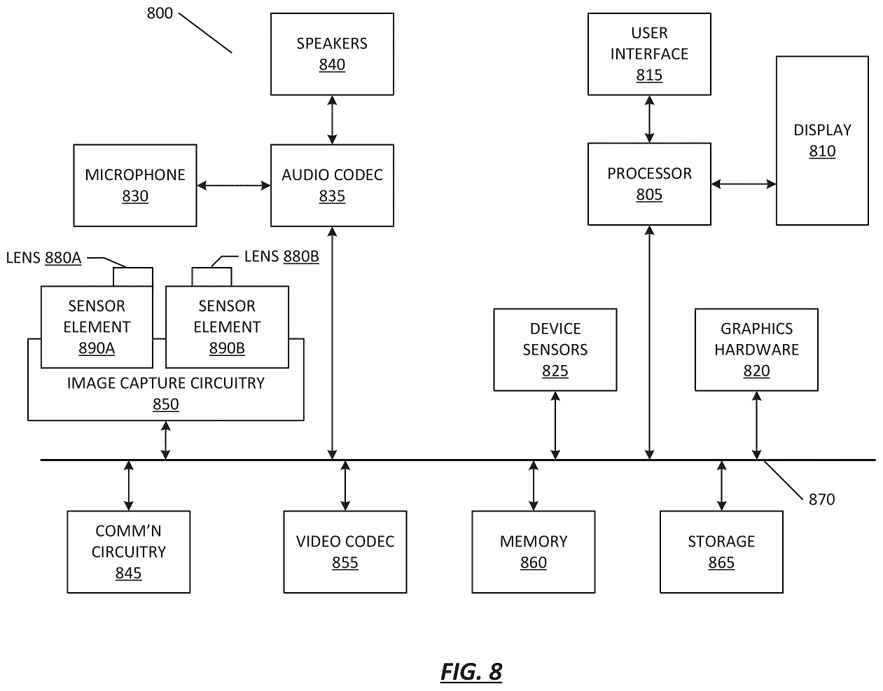

Referring now to FIG. 8, a simplified functional block diagram of illustrative multifunction electronic device 800 is shown according to one embodiment. Each of electronic devices may be a multifunctional electronic device or may have some or all of the components of a multifunctional electronic device described herein. Multifunction electronic device 800 may include some combination of processor 805, display 810, user interface 815, graphics hardware 820, device sensors 825 (e.g., proximity sensor/ambient light sensor, accelerometer and/or gyroscope), microphone 830, audio codec 835, speaker(s) 840, communications circuitry 845, digital image capture circuitry 850 (e.g., including camera system), memory 860, storage device 865, and communications bus 870. Multifunction electronic device 800 may be, for example, a mobile telephone, personal music player, wearable device, tablet computer, or the like.

Processor 805 may execute instructions necessary to carry out or control the operation of many functions performed by device 800. Processor 805 may, for instance, drive display 810 and receive user input from user interface 815. User interface 815 may allow a user to interact with device 800. For example, user interface 815 can take a variety of forms, such as a button, keypad, dial, a click wheel, keyboard, display screen, touch screen, and the like. Processor 805 may also, for example, be a system-on-chip, such as those found in mobile devices, and include a dedicated graphics processing unit (GPU). Processor 805 may be based on reduced instruction-set computer (RISC) or complex instruction-set computer (CISC) architectures or any other suitable architecture and may include one or more processing cores. Graphics hardware 820 may be special purpose computational hardware for processing graphics and/or assisting processor 805 to process graphics information. In one embodiment, graphics hardware 820 may include a programmable GPU.

Image capture circuitry 850 may include one or more lens assemblies, such as 880A and 880B. The lens assemblies may have a combination of various characteristics, such as differing focal length and the like. For example, lens assembly 880A may have a short focal length relative to the focal length of lens assembly 880B. Each lens assembly may have a separate associated sensor element 890. Alternatively, two or more lens assemblies may share a common sensor element. Image capture circuitry 850 may capture still images, video images, enhanced images, and the like. Output from image capture circuitry 850 may be processed, at least in part, by video codec(s) 855, processor 805, graphics hardware 820, and/or a dedicated image processing unit or pipeline incorporated within circuitry 845. Images so captured may be stored in memory 860 and/or storage 865.

Memory 860 may include one or more different types of media used by processor 805 and graphics hardware 820 to perform device functions. For example, memory 860 may include memory cache, read-only memory (ROM), and/or random-access memory (RAM). Storage 865 may store media (e.g., audio, image, and video files), computer program instructions or software, preference information, device profile information, and any other suitable data. Storage 865 may include one more non-transitory computer-readable storage mediums, including, for example, magnetic disks (fixed, floppy, and removable) and tape, optical media such as CD-ROMs and digital video disks (DVDs), and semiconductor memory devices such as Electrically Programmable Read-Only Memory (EPROM) and Electrically Erasable Programmable Read-Only Memory (EEPROM). Memory 860 and storage 865 may be used to tangibly retain computer program instructions or computer readable code organized into one or more modules and written in any desired computer programming language. When executed by, for example, processor 805, such computer program code may implement one or more of the methods described herein.

It is to be understood that the above description is intended to be illustrative and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). Accordingly, the specific arrangement of steps or actions shown in FIGS. 2-3 and 5-6, or the arrangement of elements shown in FIGS. 1, 4, and 6-8, should not be construed as limiting the scope of the disclosed subject matter. The scope of the invention, therefore, should be determined with reference to the appended claims, along with the full scope of equivalents to which such claims are entitled. In the appended claims, the terms “including” and “in which” are used as the plain English equivalents of the respective terms “comprising” and “wherein.”

The techniques defined herein consider the option of obtaining and utilizing a user's personal information. For example, such personal information may be utilized in order to provide a multi-user communication session on an electronic device. However, to the extent such personal information is collected, such information should be obtained with the user's informed consent such that the user has knowledge of and control over the use of their personal information.

Parties having access to personal information will utilize the information only for legitimate and reasonable purposes and will adhere to privacy policies and practices that are at least in accordance with appropriate laws and regulations. In addition, such policies are to be well-established, user-accessible, and recognized as meeting or exceeding governmental/industry standards. Moreover, the personal information will not be distributed, sold, or otherwise shared outside of any reasonable and legitimate purposes.

Users may, however, limit the degree to which such parties may obtain personal information. The processes and devices described herein may allow settings or other preferences to be altered such that users control access of their personal information. Furthermore, while some features defined herein are described in the context of using personal information, various aspects of these features can be implemented without the need to use such information. As an example, a user's personal information may be obscured or otherwise generalized such that the information does not identify the specific user from which the information was obtained.

1. A system comprising:
one or more cameras;
one or more illuminators;
one or more processors; and
one or more computer readable media comprising computer readable code executable by one or more processors to:
obtain image data captured by the one or more cameras, wherein the image data is captured when at least one of the one or more illuminators are illuminated;
determine brightness statistics from the image data;
determine whether the brightness statistics satisfies a predetermined threshold; and
determine that a proximate object is detected in accordance with a determination that the brightness statistics satisfies the predetermined threshold.

2. The system of claim 1, wherein the system comprises a wearable device, and wherein the one or more cameras are situated in front of an eye when the wearable device is worn.

3. The system of claim 2, further comprising computer readable code to:
power on a display of the device in accordance with detecting that the object is proximate to the wearable device.

4. The system of claim 2, further comprising computer readable code to:
determine that the wearable device is being worn in response to a determination that the proximate object is detected; and
in response to a determination that the wearable device is being worn, boot up one or more systems of the device.

5. The system of claim 1, wherein the computer readable code to determine whether the brightness statistics satisfies a predetermined threshold further comprises computer readable code to:
identify a number of pixels in the image data that satisfying a brightness range; and
determining whether the identified number of pixels satisfies a proximity threshold.

6. The system of claim 1, wherein the one or more cameras comprise one or more infrared cameras, and wherein the one or more illuminators comprise one or more light emitting diodes (LEDs).

7. The system of claim 1, further comprising computer readable code to:
obtain additional image data captured by the one or more cameras;
determine whether brightness statistics for the additional image data satisfy a predetermined threshold;
determine a lack of proximate object in accordance with a determination that the brightness statistics for the additional image data fail to satisfy the predetermined threshold; and
power down a display in accordance with the determination of the lack of proximate object.

8. The system of claim 1, wherein the computer readable code to determine brightness statistics from the image data further comprises computer readable code to:
identify a lit image and an unlit image in the image data;
remove ambient light from the lit image based on the unlit image to obtain a modified lit image; and
apply a mask to the lit image to obtain a masked image,
wherein the brightness statistics are determined from a region of interest in the masked image.

9. A non-transitory computer readable media comprising computer readable code executable by one or more processors to:
obtain image data captured by one or more cameras of a device, wherein the image data is captured when one or more illuminators are illuminated;
determine brightness statistics from the image data;
determine whether the brightness statistics satisfies a predetermined threshold; and
determine that a proximate object is detected in accordance with a determination that the brightness statistics satisfies the predetermined threshold.

10. The non-transitory computer readable medium of claim 9, wherein the device comprises a wearable device, and wherein the one or more cameras are situated in front of an eye when the wearable device is worn.

11. The non-transitory computer readable medium of claim 10, further comprising computer readable code to:
power on a display of the device in accordance with detecting that the object is proximate to the wearable device.

12. The non-transitory computer readable medium of claim 10, further comprising computer readable code to:
determine that the wearable device is being worn in response to a determination that the proximate object is detected; and
in response to a determination that the wearable device is being worn, boot up one or more systems of the device.

13. The non-transitory computer readable medium of claim 9, wherein the computer readable code to determine whether the brightness statistics satisfies a predetermined threshold further comprises computer readable code to:
identify a number of pixels in the image data that satisfying a brightness range; and
determining whether the identified number of pixels satisfies a proximity threshold.

14. The non-transitory computer readable medium of claim 9, wherein the one or more cameras comprise one or more infrared cameras, and wherein the one or more illuminators comprise one or more light emitting diodes (LEDs).

15. The non-transitory computer readable medium of claim 9, further comprising computer readable code to:
obtain additional image data captured by the one or more cameras;
determine whether brightness statistics for the additional image data satisfy a predetermined threshold;
determine a lack of proximate object in accordance with a determination that the brightness statistics for the additional image data fail to satisfy the predetermined threshold; and
power down a display in accordance with the determination of the lack of proximate object.

16. The non-transitory computer readable medium of claim 9, wherein the computer readable code to determine brightness statistics from the image data further comprises computer readable code to:
identify a lit image and an unlit image in the image data;
remove ambient light from the lit image based on the unlit image to obtain a modified lit image; and
apply a mask to the lit image to obtain a masked image,
wherein the brightness statistics are determined from a region of interest in the masked image.

17. A method comprising:
obtaining image data captured by one or more cameras of a device, wherein the image data is captured when one or more illuminators are illuminated;
determining brightness statistics from the image data;
determining whether the brightness statistics satisfies a predetermined threshold; and
determining that a proximate object is detected in accordance with a determination that the brightness statistics satisfies the predetermined threshold.

18. The method of claim 17, wherein the device comprises a wearable device, and wherein the one or more cameras are situated in front of an eye when the wearable device is worn.

19. The method of claim 18, further comprising:
powering on a display of the device in accordance with detecting that the object is proximate to the wearable device.

20. The method of claim 17, wherein determining the brightness statistics from the image data further comprises:
identifying a lit image and an unlit image in the image data;
removing ambient light from the lit image based on the unlit image to obtain a modified lit image; and
applying a mask to the lit image to obtain a masked image,
wherein the brightness statistics are determined from a region of interest in the masked image.
